(19) United States
(12) Patent Application Publication
(10) Pub. No.: US 2019/0060162 A1
(43) Pub. Date: Feb. 28, 2019

(54) PHALLIC DEVICE ACCESSORY AND SYSTEM

(71) Applicant: WOMBAT CREATIONS, LLC, Boca Raton, FL (US)

(72) Inventor: Bruce Martin, Boca Raton, FL (US)

(21) Appl. No.: 15/910,347

(22) Filed: Mar. 2, 2018

Related U.S. Application Data
(63) Continuation-in-part of application No. 15/688,468, filed on Aug. 28, 2017, now abandoned.

(51) Int. Cl. A61H 19/00

(52) U.S. Cl. CPC A61H 19/50; A61H 2201/0153; A61H 19/44

(57) ABSTRACT

An intimate accessory system has a phallic device support arm including a first end and a second end opposite the first end; an extension arm portion between the first end and the second end; a gripping handle portion disposed at the first end, the gripping handle portion dimensioned and configured to receive a grip of a human user; a phallic device coupling portion disposed at the second end, the phallic device coupling portion dimensioned and configured to removeably couple to a phallic device; and a hook portion forming an arcuate shape between the phallic device coupling portion and the extension arm portion.

### CROSS REFERENCE

This application is a continuation in part of U.S. patent application Ser. No. 15/688,468, filed Aug. 28, 2017, and titled “Phallic Device Accessory and System,” the entirety of which is hereby incorporated by reference.

### FIELD OF THE INVENTION

The present invention relates generally to intimate devices, and, more particularly, relates to a phallic device extension accessory and system.

### BACKGROUND OF THE INVENTION

Intimate accessories such as phallic devices are well-known and have been used as male reproductive organ substitutes for many years. Such devices are used for sexual pleasure. Known phallic devices are limited in their positional use and reach and, therefore, in their flexibility and versatility of use in both an individual, as well as, a couple setting.

Therefore, a need exists to overcome the problems with the prior art as discussed above.

### SUMMARY OF THE INVENTION

The invention provides a phallic device accessory and system that overcomes the hereinafore-mentioned disadvantages of the heretofore-known devices and methods of this general type.

With the foregoing and other objects in view, there is provided, in accordance with the invention, an intimate accessory system with a phallic device support arm including: a first end and a second end opposite the first end; an extension arm portion between the first end and the second end comprised of at least two telescoping portions and having a clutch clamp between the telescoping portions, the extension arm portion having an adjustable length; a gripping handle portion disposed at the first end, the gripping handle portion dimensioned and configured to receive a grip of a human user; a phallic device coupling portion disposed at the second end, the phallic device coupling portion dimensioned and configured to removeably couple to a phallic device; and a hook portion forming an arcuate shape between the phallic device coupling portion and the extension arm portion.

In accordance with another feature of the present invention, the hook portion is disposed to orient an orifice-insertion end portion of the phallic device in a direction towards the gripping handle portion when the phallic device is coupled to the phallic device coupling portion, the orifice-insertion end portion being dimensioned and configured for insertion within a human sexual orifice.

In accordance with yet another feature of the present invention, a length of the extension arm portion corresponds to at least one-third of an average height of an adult human.

In accordance with yet another feature of the present invention, a length of the extension arm portion is at least 2 feet.

In accordance with yet another feature of the present invention, a length of the extension arm portion is at least 3 feet.

In accordance with yet another feature of the present invention, the hook portion is selectively bendable a from a first bent position to a second bent position different from the first bent position; and the hook portion has a rigidity sufficient to retain, with the phallic device coupled thereto, the first bent position and the second bent position, without external support forces.

In accordance with an additional feature of the present invention, the hook portion is formed as a flexible, articulatable gooseneck tubing.

In accordance with another feature of the present invention, the gripping handle portion and the extension arm portion are fixedly coupled to one another; and the hook portion is formed as a flexible hinge portion operably configured to selectively rotate the phallic device, relative to the extension arm portion, within at least a 45 degree range of movement.

In accordance with yet another feature of the present invention, the phallic device coupling portion includes one of a female connector portion and a male connector portion dimensioned and configured to matingly couple to a corresponding one of a female connector portion and a male connector portion at a proximal end of the phallic device for removeably coupling the phallic device to the phallic device support arm.

In accordance with another feature of the present invention, the phallic device support arm further includes an actuator at the gripping handle portion; and the actuator is electrically coupled to the phallic device and operably configured to permit a user to selectively vibrate the phallic device when coupled to the phallic device coupling portion.

In accordance with a further feature, an embodiment of the present invention further includes a conductor, at least a portion of the conductor extending along an interior of the hook portion from the gripping handle portion to the phallic device coupling portion.

In accordance with another feature of the present invention, the extension arm portion is formed as at least one hollow tube.

In accordance with another feature, an embodiment of the present invention includes an intimate accessory system with a phallic device support arm including: a first end and a second end opposite the first end; an extension arm portion between the first end and the second end; a gripping handle portion disposed at the first end, the gripping handle portion dimensioned and configured to receive a grip of a human user; and a hook portion; and a phallic device fixedly coupled to the second end of the phallic device support arm, the hook portion being formed as an arcuate shape between the phallic device and the extension arm portion.

In accordance with another feature, another embodiment of the present invention includes an intimate accessory kit with interchageable phallic devices including a phallic device support arm with a first end and a second end opposite the first end; an extension arm portion between the first end and the second end; a gripping handle portion disposed at the first end, the gripping handle portion dimensioned and configured to receive a grip of a human user; a phallic device coupling portion disposed at the second end of the phallic device support arm; and a hook portion forming an arcuate shape between the phallic device coupling portion and the extension arm portion; and a first phallic device dimensioned and configured to removeably couple to the phallic device coupling portion.

In accordance with a further feature, an embodiment of the present invention further includes a second phallic device dimensioned and configured to removeably couple to the phallic device coupling portion, the second phallic device being different from the first phallic device.

Although the invention is illustrated and described herein as embodied in a phallic device accessory and system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the phallic device support arm. Those skilled in the art can understand the specific meanings of the above-mentioned terms in the embodiments of the present invention according to the specific circumstances

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective side view of an intimate accessory system in accordance with an embodiment of the present invention;

FIG. 2 is a perspective side view of the intimate accessory system of FIG. 1 in couple-use, in accordance with the present invention;

FIG. 3 is a perspective side view of the intimate accessory system of FIG. 1 in individual-use, in accordance with the present invention;

FIG. 4 is a perspective side view of an alternative embodiment of the intimate accessory system in accordance with the present invention;

FIG. 5 is an enlarged, fragmentary view of a phallic device removable coupling feature of the intimate accessory system of FIG. 1, in accordance with the present invention;

FIG. 6 is a perspective side view of an alternative shape of the intimate accessory system shown in FIG. 4, in accordance with the present invention;

FIG. 7 is a perspective view of an intimate accessory system in accordance with an embodiment of the present invention;

FIG. 8 is a perspective exploded view of a clutch clamp assembly for use in an adjustable handle of an intimate accessory system in accordance with an embodiment of the present invention; and

FIG. 9 is perspective exploded view of a clamp system for use with an intimate accessory system in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient phallic device extension arm accessory and system. Embodiments of the invention provide an elongated extension arm that substantially extends a conventional reach of a phallic device. In addition, embodiments of the invention provide a hook portion that orients an orifice-insertion end of the phallic device in a direction towards the gripping handle portion. In addition, embodiments of the invention provide a flexible gooseneck hook portion that is selectively rotatable within a free range of motion, while also providing sufficient rigidity and stiffness to hold a selected, rotated position for use.

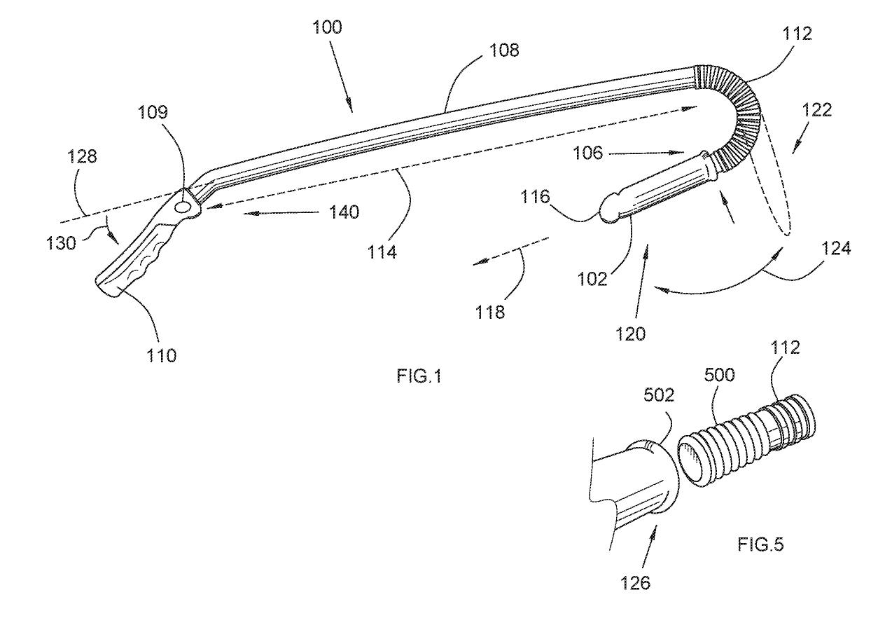

Referring now primarily to FIG. 1, one embodiment of the present invention is shown in a perspective side view. FIG. 1 shows several advantageous features of the present invention, but, as will be described below, the invention can be provided in several shapes, sizes, combinations of features and components, and varying numbers and functions of the components. The first example of an intimate accessory system, as shown in FIG. 1, includes a phallic device support arm 100 coupled to a phallic device 102.

The phallic device support arm 100 may be considered to have a first end 104 and a second end 106. The first end 104 may be disposed opposite to the second end 106. The phallic device support arm 100 may further include an extension arm portion 108, a gripping handle portion 110, and a hook portion 112.

The gripping handle portion 110 may be provided to allow a user to conveniently grip the phallic device support arm 100 during use. Stated another way, the gripping handle portion 110 is dimensioned and configured to receive a grip of a human user's hand. The gripping handle portion 110 may be disposed at the first end 104 of the phallic device support arm 100. In one embodiment, the gripping handle portion 110 is fixedly connected to the extension arm portion 108. In another embodiment, the gripping handle portion 110 is integral with (or considered a distal end of) the extension arm portion 108. The gripping handle portion 110 may be made of any known material for such handles, such as, for example, plastic or other polymer-based material. In a preferred embodiment, the gripping handle portion 110 may be generally cylindrical in shape so as to provide a generally rounded surface for the user to grip. In one embodiment, the gripping handle portion 110 includes a plurality of grooves shaped to receive the user's fingers for gripping. In other embodiments, one or more user control and/or power actuators 109 (e.g., buttons) may be provided at, or proximate to the gripping handle portion 110 for the users to selectively depress or otherwise activate for controlling, or supplying power for various features of the intimate accessory device and system. In yet other embodiments, the gripping handle portion 110 may be made with other shapes, materials, and configurations. In some embodiments the gripping handle 110 can be angled from an axis 128 of an extension arm portion 108 by an angle 130. The angle 130 can be downward, towards the phallic device 102, on a user-side of the intimate accessory system (e.g. the side on which the user will be located during use). The angle 30 can be between 30 and 45 degrees in some embodiments, and aligns with the natural angle of a user's hand when holding the gripping portion 110 during use. If the gripping portion 110 were angled in the opposite direction from that shown, with respect to axis 128, it would not align with the natural angle of the user's hand when the user's hand is positioned between about elbow level and neck level, when the extension arm portion is in front of the user, or above the user's head when the extension arm portion 108 is behind the user (the “user” referring to the person holding the gripping portion 110).

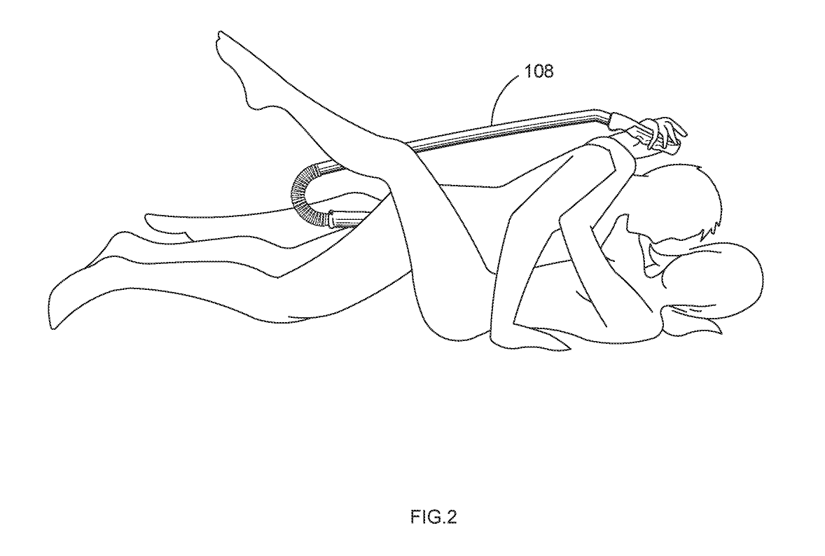

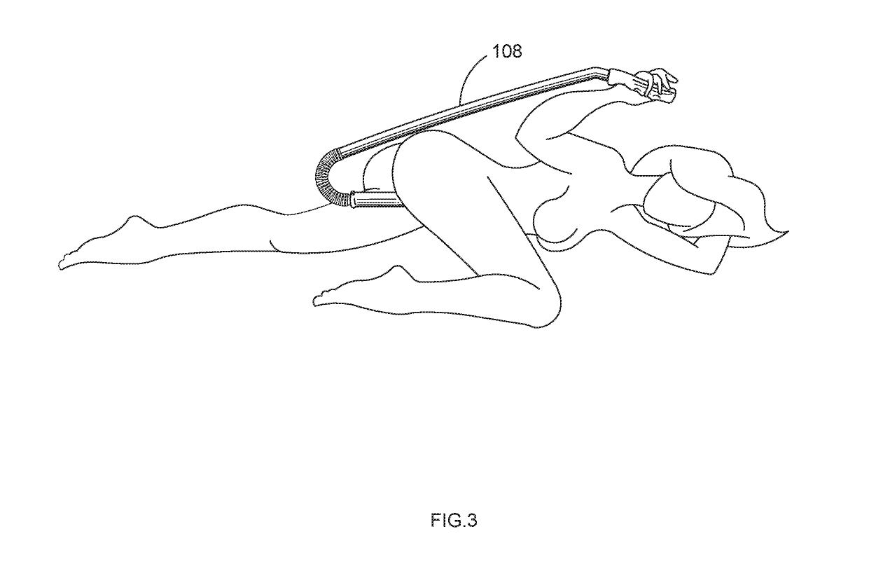

The extension arm portion 108 provides an advantageous, extended reach for the user to utilize the phallic device 102 in a wider variety of ways, angles, and/or positions as compared to conventional phallic devices (see for example FIGS. 2 and 3). The extension arm portion 108 may be considered to be between the first end 104 and the second end 106 of the phallic device support arm 100, extending an overall length and reach of the phallic device support arm 100.

In one embodiment, the extension arm portion 108 may be a hollow tube. In another embodiment, the extension arm portion 108 may be a plurality of hollow tubes (e.g., three hollow tube) coupled to one another to form a singular elongated tubular body between the handle portion 110 and the hook portion 112. In another embodiment, the extension arm portion 108 may not be an entirely hollow tube, but may be substantially hollow, enclosing other ancillary support structures, such as, for example, a conductor 400 or wire (see FIG. 1) electrically coupling to the phallic device 102 to provide additional features, such as a vibration effect. In yet another embodiment, the extension arm portion 108 may be a non-tubular extension arm, having, for example, other non-circular cross-sections. In one embodiment, the extension arm portion 108 may be formed as a solid bar, a rod, a shaft, a pole, a stick, etc., or other length extending structure. The extension arm portion 108 may extend in a substantially linear direction (as shown in FIG. 1), or may, alternatively, extend in a substantially curved direction. In yet other embodiments, the extension arm portion may extend in a zigzag-type pattern, or have one or more turns. Importantly, the extension arm portion 108 should extend the reach of the user so that the attached phallic device 102 may be used in more of a variety of ways, angles, positions, or the like, as compared to conventional phallic devices.

In one embodiment, the extension arm portion 108 has a length 114. As used herein, the “length 114” of the extension arm portion 108 is intended to indicate the overall distance or reach provided by the extension arm portion 108 between opposite absolute first and second ends of the extension arm portion 108. In one embodiment, the length 114 may be considered a distance between the gripping handle portion 110 and the hook portion 114 when the extension arm portion 108 is disposed directly between the handle portion 110 and the hook portion 112, as shown in the exemplary embodiment depicted in FIG. 1. In other embodiments, intermediate ancillary components (not shown) may be disposed between the extension arm portion 108, the handle portion 110, and/or the hook portion 112. In one embodiment, the length 114 of the extension arm portion 108 corresponds to at least one-third of an average height of an adult human. Such dimension should be known or reasonably determinable by those of ordinary skill in the art. To provide one example, one known measurement for the average height of an adult human is 5 feet, 6 inches. Thus, a measurement of one-third of 5 feet, 6 inches can be easily determined. As shown in FIGS. 2 and 3, the extension arm portion 108 advantageously provides a longer reach, relative to the user's hand, during use. In another embodiment, the length 114 of the extension arm portion 108 may be at least 2 feet. In yet another embodiment, the length 114 of the extension arm portion 108 may be at least 3 feet. In yet a further embodiment, the length 114 of the extension arm portion 108 may correspond to at least one-half of the average height of an adult human. In other embodiments, the extension arm portion 108 may have other lengths 114 outside of these ranges, but should still provide a relatively long reach for the user as compared to conventional phallic devices 102.

The extension arm portion 108 may be made of a rigid metal material in one embodiment. In other embodiments, the extension arm portion 108 may be made of other known materials, such as, for example, plastic or other polymer-based materials.

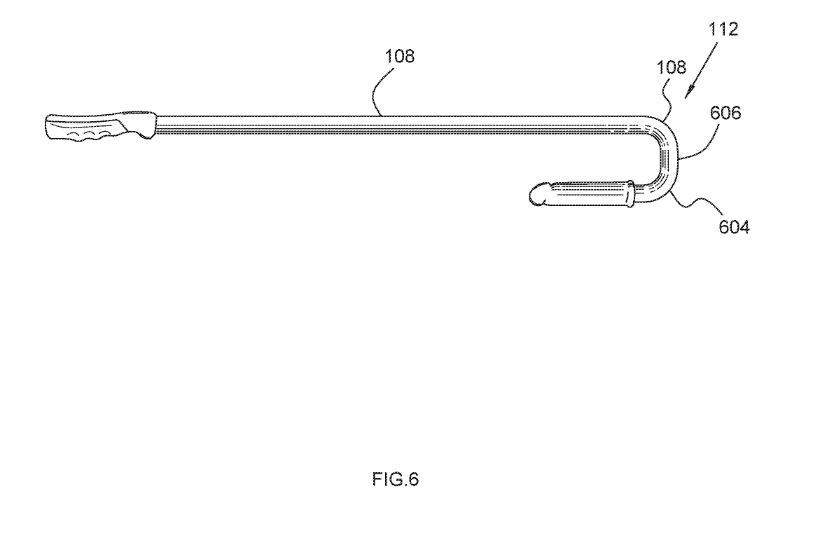

The hook portion 112 may form an arcuate shape between the phallic device 102 and the extension arm portion 108. Stated another way, the hook portion 112 provides a curved or angled shape extending from the second end 106 of the extension arm portion 108 towards the phallic device 102. In one embodiment, the hook portion 112 is disposed to orient the phallic device 102 in a direction 118 towards the gripping handle portion 110 when the phallic device 102 is coupled to the hook portion 112. More specifically, in a further embodiment, the hook portion 112 is disposed to orient an orifice-insertion end 116 of the phallic device 102 in the direction 118 towards the gripping handle portion 110. Such arrangement is an improvement over known phallic devices in which a user gripping portion is adjacent to and oriented in generally the same direction as the phallic-shaped portion. Some known phallic devices may have an orifice-insertion end/tip portion that is slightly angular relative to its gripping portion. That being said, in embodiments of the present invention, the novel and inventive arrangement of the extension arm portion 108 and the hook portion 112, relative to the gripping handle portion 110 and the orientation of the phallic device 102, provides for a flexibility of use and reach of the phallic device 102 not available in existing phallic devices and related intimate accessories. Continuing further, embodiments of the present invention provide a wider variety of ways, angles, and/or positions of use of the attached phallic device 102, as compared to conventional phallic devices (see for example FIGS. 2 and 3 showing use of the same). FIG. 6 shows one embodiment where the shape of the hook portion 112 has more of a square shape. In this embodiment, the hook portion has two flexible portions 602 and 604 and a relatively straight portion 606. Of course, the invention is not limited to any particular shape of the hook portion 112.

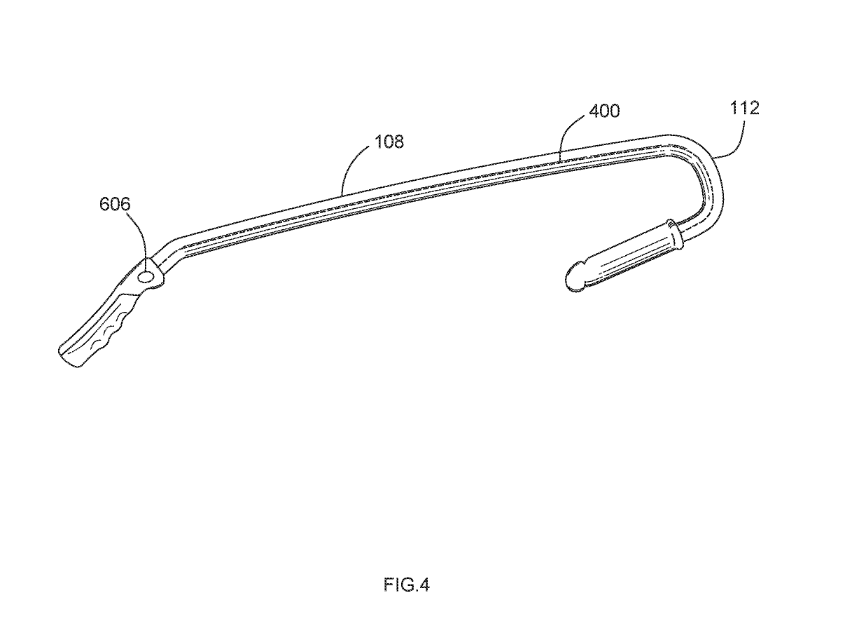

In one embodiment, the hook portion 112 is a fixed structure relative to the extension arm portion 108, as shown in the embodiment depicted in FIG. 4. In a further embodiment, the extension arm portion 108 may be integral with, or otherwise fixedly connected to the hook portion 112 to form an elongated hook-like structure. The hook portion 112 may be made of the same material as the extension arm portion 108, such as, for example, metal, plastic, or other polymer-based material. In other embodiments, the hook portion 112 may be made of a material that is different from a material that the extension arm portion 108 is made of.

In another embodiment, the hook portion 112 may be selectively moveable, or bendable relative to the extension arm portion 108, as shown in the embodiment depicted in FIG. 1, which depicts the hook portion 112 as flexible gooseneck tubing. In one embodiment, the hook portion 112 is formed so as to be selectively moveable or rotatable, relative to the extension arm portion 108, within a range of movement. In a further embodiment, the hook portion 112 may be formed as a flexible hinge portion operably configured to selectively rotate the phallic device 102, relative to the extension arm portion, within a range of movement. In a further embodiment, the range of movement may be at least a 45 degree range of movement, relative to the extension arm portion 108. In a further embodiment, the range of movement may be at least a 180 degree range of movement, relative to the extension arm portion 108. In yet a further embodiment, the range of movement may be a 360 degree range of movement. Advantageously, in embodiments with the hook portion 112 being a flexible, bendable hook portion 112 the range of angles and/or positions of use/insertion of the phallic device 102 may be increased.

In yet further embodiments of a flexible hook portion 112, the hook portion 112 may be considered selectively bendable from at least a first bent position 120 to a second bent position 122, different from the first bent position 120, while still having a rigidity sufficient to selectively retain at least the first bent position 120 and (separately) the second bent position 122, without external support forces. Stated yet another way, the flexible hook portion 112 may be considered articulatable along a movement path 124. The movement path 124 may be at least 45 degrees in one embodiment. The movement path 124 may be at least 90 degrees in another embodiment. In yet further embodiments, the movement path 124 may be at least 180 degrees or may be a full 360 degree movement path 124.

As one example of such articulatable structures, the hook portion 112 may be formed as a flexible gooseneck including a jointed, articulatable tube. In a further embodiment, the flexible gooseneck 112 may include two coaxially positioned, loosely-wound springs. Each spring may have a pitch defining a space between consecutive windings. An outer spring may have, for example, a cross-section and a pitch that may approximate or equal the cross-section of the inner spring. The inner spring may also have a cross-section and the outer diameter of the inner spring may be sized such that the inner spring fits snugly within, and pressably against, the outer spring. The two springs may be positioned in a manner that allows the inner spring to be stiffer than the outer spring. Other configurations of the flexible, articulatable gooseneck 112 are possible with various embodiments of the present invention.

In yet a further embodiment, to provide additional support for position retention of the phallic device 102 coupled to the flexible gooseneck 112, the flexible gooseneck 112 (or an alternative embodiment flexible hook portion 112) may include a lock or clamp (not shown) that may allow the user to selectively lock the flexible gooseneck 112 in a selected position along the movement path 124.

In one embodiment, the flexible hook portion 112 may be formed as a hollow tubular structure. In another embodiment, the flexible hook portion 112 may not be entirely hollow, but may be substantially hollow, enclosing ancillary support structures, such as, for example, the conductor 400 (see FIG. 4) that may electrically couple to the phallic device 102 to provide additional features, such as a vibration effect.

Turning now to a description of the phallic device 102 that may be used with the present invention, the phallic device 102 may have an elongated shape, as with many known phallic devices. In one embodiment, a depth of the phallic device 102 may be any known depth of such devices, such as, for example, 3 to 13 inches. The girth of the phallic device 102 may be any known girth of such devices, such as, for example, 2.5 to 4.5 inches. In another embodiment, the phallic device 102 may be other shapes, such as, circular. In yet another embodiment, the phallic device 102 may be considered cylindrical in shape with a convex shaped end (orifice-insertion end portion 116). The orifice-insertion end portion 116 may be considered the sexual orifice (e.g., vaginal, anal) insertion end of the phallic device 102. Stated another way, the orifice-insertion end portion 116 should be shaped and configured for sexual application as a male reproductive organ substitute. More specifically, the orifice-insertion end portion 116 should be sized, shaped, and configured for sexual application, specifically, penetration into a human orifice (e.g., vagina), as with known phallic devices. Accordingly, it may be a rounded end, or may be considered semi-circular or have a slightly pointed tip. Many shapes for various male reproductive organ substitutes are known and may be provided with embodiments of the present invention.

The phallic device 102 may be made of a silicone material. In another embodiment, the phallic device 102 may be made of another polymer-based material, or any other known material that phallic devices are generally constructed of. In one embodiment, the phallic device 102 may be made of a pliable material. In other embodiments, the phallic device 102 may be made of a substantially firm material. In yet other embodiments, the phallic device 102 may be provided with a rigid core, yet be surrounded by a more flexible, resilient material on its exterior surface.

In one embodiment, the phallic device 102 may have a smooth texture, or exterior surface. In other embodiments, the phallic device 102 may have a rough, texturized exterior surface. In one embodiment, the phallic device 102 may have a generally linear shape. In other embodiments, the phallic device 102 may be curve-shaped. In yet other embodiments, the phallic device 102 may have additional arms or protrusions extending therefrom. For example, the phallic device 102 may have additional arms or protrusions extending from the main body for clitoral stimulation, for example, or other non-penetration stimulation. The phallic device 102 may be provided with an exterior surface of any known color.

In one embodiment, the phallic device 102 may be vibrating. In another embodiment, the phallic device 102 may be non-vibrating. In yet another embodiment, the phallic device 102 may include at least one vibrating element (now shown) disposed to vibrate responsive to the user selection (e.g., depression) of the actuator 109 (e.g., button) disposed on or proximate to the handle portion 110 at the opposite end of the phallic device support arm 100. The vibrating element may be, for example, a motor electrically coupled to the actuator 109, such as a button or a switch, disposed at the handle portion 110. More specifically, in one embodiment, the actuator 109 may be electrically coupled to a control circuitry, which control circuitry may be electrically coupled to the vibrating element by, for example, the conductor 400 (see FIG. 4). Stated another way, the conductor 400 may electrically couple the actuator 109 to the motor in the phallic device 102. Accordingly, the conductor 400 may extend continuously within and along the extension arm portion 108 and the hook portion 112 so as to be electrically coupled to the vibrating element in the phallic device 102. In yet other embodiments, the phallic device 102 may be made of other materials and with various other properties and features that known phallic devices are generally constructed of

Referring now primarily to FIG. 5, with brief reference to FIGS. 1 and 4, in one embodiment, the phallic device 102 may be removeably couplable to the phallic device support arm 100 (rather than being fixedly coupled thereto as in some other embodiments of the present invention). More specifically, the phallic device 102 may be removeably couplable to a phallic device coupling portion 500, which may disposed at a distal end of the hook portion 112. The phallic device coupling portion 500 may be dimensioned and configured to matingly, removeably couple to a mating hook coupling portion 502, which may be disposed at a proximal end 126 of the phallic device 102, as depicted in the exemplary embodiment shown in FIG. 5. Stated another way, the hook portion 112 extends from the intermediate extension arm portion 108 toward the phallic device coupling portion 500 so that the phallic device 102 may be removeably coupled at the second end 106 of the phallic device support arm 100.

The phallic device coupling portion 500 may be integral with the hook portion 112 in some embodiments, and may, in other embodiments, be separate from but connected to the hook portion 112. Likewise, the hook coupling portion 502 may be integral with the proximal end 126 of the phallic device 102 in some embodiments, or may, in other embodiments, be separate from but connected to the distal end of the phallic device 102.

The phallic device coupling portion 500 may, for example, include helical threads shaped to mate with mating helical threads on the hook coupling portion 502. In another embodiment, the phallic device coupling portion 500 may include one or more prongs shaped to mate with mating female receptacles defined by the hook coupling portion 502 of the phallic device 102. The phallic coupling portion 500 may include one of a female connector portion (e.g., receptacles, threads, etc.) and a male connector portion (e.g., prongs/protrusions, mating threads, etc.) dimensioned and configured to matingly couple to a corresponding one of a female connector portion and a male connector portion at the proximal end 126 of the phallic device 102. Any known mating coupling or other selectively fastening mechanisms may be used with such embodiments of the present invention.

In embodiments in which the phallic device 102 is both vibratory and removably couplable to the support arm 100, the coupling portions 500 and 502 may also include an electrically coupling feature, particularly if the actuator 109 for the vibratory effect is located at the support arm 100 and the vibration element is located at the phallic device 102. For example, one or more electrically conductive lines (e.g., the conductor 400) may extend continuously from the actuator 109, along the interior of the extension arm portion 108, through the hook portion 112, to an electrical terminal disposed at the phallic device coupling portion 500. A second electrical terminal may be disposed at the hook coupling portion 502 of the phallic device 102 to receive vibration on/off commands (or speed or vibration variation control signals) and/or a power supply from the phallic device support arm 100, through the one or more electrically conductive lines. In other embodiments, power or commands for the vibratory effect may be supplied by a battery or circuitry, respectively, within the phallic device 102 itself.

In one embodiment, the intimate accessory system of the present invention may be formed as an intimate accessory kit with the phallic device support arm 100 and at least one phallic device 102 removably couplable to one another. In a further embodiment, the kit may include at least two phallic devices 102, with each being different from the other(s). For example, one phallic device 102 may have a shape, size, and/or surface feel that is different from a shape, size, and/or surface feel of the other phallic devices 102 within the kit. Advantageously, the intimate accessory kit may allow users to interchangeable use various types, shapes, sizes, and configuration of phallic devices 102 as desired.

Referring now briefly to FIGS. 2-3, one or more users may use the phallic device support arm 100 for pleasurable stimulation as an individual-use or couple-use device. Advantageously, the phallic device support arm 100, with the extension arm portion 108 and the hook portion 112, provides an extended reach for the user to utilize the phallic device 102 in a wider variety of ways, angles, and/or positions as compared to conventional phallic devices. In embodiments in which the phallic devices is removeably couplable to the support arm 100, the variety and flexibility of use of the intimate accessory system is increased even more so.

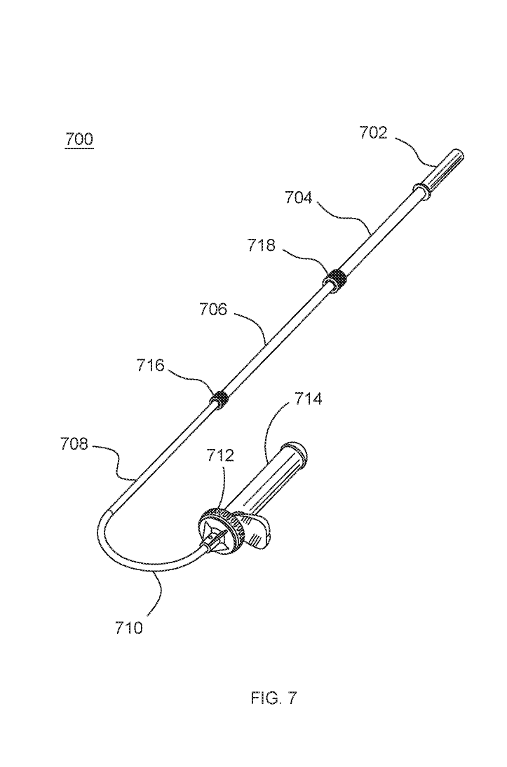

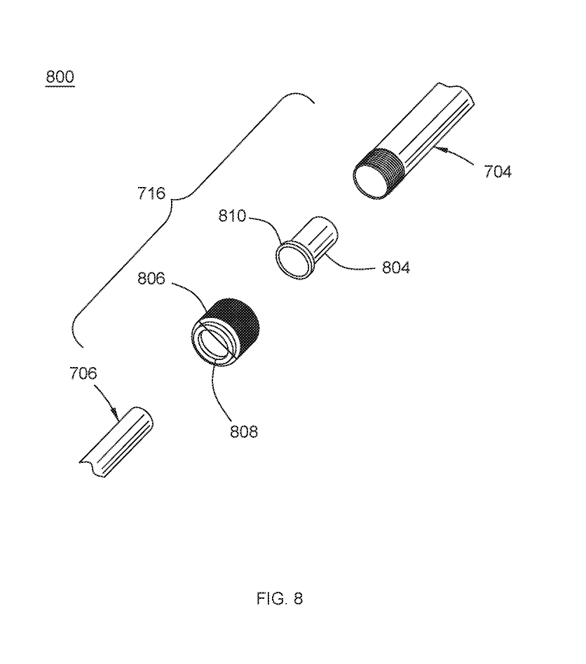

FIG. 7 is a perspective view of an intimate accessory system 700 in accordance with an embodiment of the present invention. Embodiments such as those represented by FIG. 7 include an adjustable length extension arm portion that is comprised of several telescoping portions 704, 706, 708, as shown. At least two telescoping portions are needed to be able to adjust the length of the extension arm portion. As shown, for example, portion 708 telescopes into portion 706, which telescopes into portion 704. Portions 704 and 706 have a bore with an inner diameter large enough to accommodate the outer diameter of portions 706, 708, respectively. Threaded clutch clamps 716, 718 can be loosened or tightened to allow adjustment and then fix the telescoping portions 706, 708 in place at the desired length. A handgrip 702 can be provided at the end of portion 704 (which may or may not be angled as in FIG. 1). A hook portions 710 connects the extension arm portion to a phallic device coupling portion 712, which acts to hold and retain a phallic device 714. In the embodiment of FIG. 7, the phallic coupling portion 712 comprises or rotary clamp that engages and retains a base flange of the phallic device 714. Other than the specific features shown here in FIG. 7, the embodiments represented by the intimate accessory system of FIG. 7 can incorporate features show in FIGS. 1-6 as well.

In general, the extension arm portion of the intimate accessory system 700 can be adjusted to different lengths to suit different situations for the user or users. In some embodiments the length can be adjust from a minimum of about two feet to a maximum of about four feet. The threaded clutch clamps 716, 718 allow for quick adjustment during intimate activity.

FIG. 8 is a perspective exploded view of a clutch clamp assembly 800 for use in an adjustable handle of an intimate accessory system in accordance with an embodiment of the present invention. The clutch clamp assembly 800 can represent clutch clamps 716, 718 of FIG. 7. A first telescoping portion 704 includes a threaded end 802 over which a clutch collar 806 threads. A clutch bushing 804 resides in the end of the first telescoping portion 704, and the second telescoping portion 706 passes through the clutch collar and clutch bushing, into the first telescoping portion 704. Upon tightening the clutch collar 806 on the threads 802, a narrowed portion 808 on the inside of the clutch collar engages a lip 810 of the clutch busing 804, and squeezes it against the end of the first telescoping portion 704 (the outside diameter of the lip 810 is larger than the inside diameter of the bore of the first telescoping portion 704). As a result, the clutch busing bears against the second telescoping portion. The clutch bushing is a compliant, polymeric material that exhibit elasticity, and returns to its original shape when the pressure is relieved (e.g. when the clutch collar is unscrewed), allowing the second telescoping portion 706 to pass freely. The clutch collar 806 can be textured on the outside to facilitate the user's grasp when tightening and untightening the clutch collar 806.

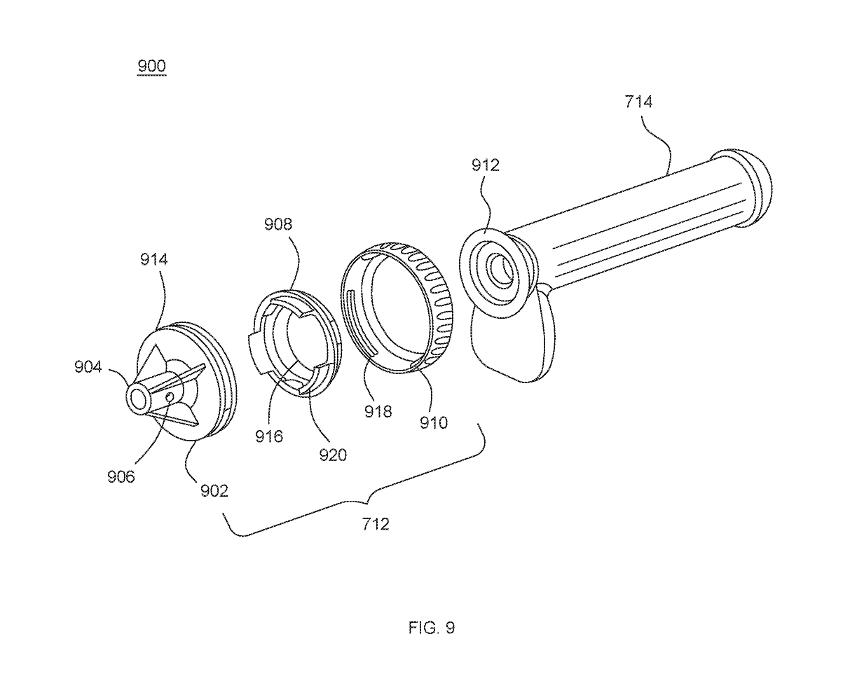

FIG. 9 is perspective exploded view of a clamp system 900 for use with an intimate accessory system in accordance with an embodiment of the present invention. The clamp system 900 can be used as a phallic device coupling portion to couple and retain a phallic device 714 to the intimate accessory system. The clamp system 900 includes a clamp base 902 that attaches to the second end of the intimate accessory system, at the end of the hook portion 710. The clamp base 902 can include a receiving boss 904 that has a channel for receiving an end of the hook portion 710, and a fastener hole 906 through which a pin or other fastener can be placed, coupling the clamp base 902 to the end of the hook portion 710. A clamp 908 fits within the clamp base 902 and can have anti-rotation features 920 that engage corresponding features in the clamp base (e.g. ribs) to prevent the clamp 908 from rotating. A clamp ring 910 goes over the clamp 920 and has threads 918 that engage corresponding threads 914 on the clamp base 902 to tighten/untighten. The phallic device 714 is held in the clamp assembly 900 by a base flange 912 at the base of the phallic device 714. The base flange is a skirt of material that extends outward from the base of the phallic device 714 and can define a hollow portion under it. The base flange 912 is placed through the clamp ring 910 and over a clamp flange 916 that extends inward from the outer diameter of the clamp 908. Thus, the base flange 912 is captured between the inside of the clamp ring or clamp collar 910 and the clamp flange 916. When the clamp collar 910 is tightened over the threads 914 of the clamp base 902, the base flange 912 will be compressed between the clamp collar 910 and the clamp flange, thereby retaining the phallic device 714 in place.

A phallic device extension arm accessory and system has been disclosed that provides an elongated extension arm that substantially extends a conventional reach of a phalli device. In addition, embodiments of the invention provide a hook portion that orients an orifice-insertion end of the phallic device in a direction towards the gripping handle portion. In addition, embodiments of the invention provide a flexible gooseneck hook portion that is selectively rotatable within a free range of motion, while also providing sufficient rigidity and stiffness to hold a selected, rotated position for use.

What is claimed is:

1. An intimate accessory system comprising:
a phallic device support arm including:
a first end and a second end opposite the first end;
an extension arm portion between the first end and the second end comprised of at least two telescoping portions and having a clutch clamp between the telescoping portions, the extension arm portion having an adjustable length;
a gripping handle portion disposed at the first end, the gripping handle portion dimensioned and configured to receive a grip of a human user;
a phallic device coupling portion disposed at the second end, including a threaded clamp portion that engages and retains a base flange of a phallic device; and
a hook portion forming an arcuate shape between the phallic device coupling portion and the extension arm portion.

2. The intimate accessory system in accordance with claim 1, wherein:
the hook portion is disposed to orient an orifice-insertion end portion of the phallic device in a parallel with the gripping handle portion when the phallic device is coupled to the phallic device coupling portion, the orifice-insertion end portion being dimensioned and configured for insertion within a human sexual orifice.

3. The intimate accessory system in accordance with claim 1, wherein:
the adjustable length of the extension arm portion can be adjusted to at least one-thirds of an average height of an adult human.

4. The intimate accessory system in accordance with claim 1, wherein:
a minimum length of the adjustable length of the extension arm portion is at least 2 feet.

5. The intimate accessory system in accordance with claim 1, wherein:
a minimum length of the adjustable length of the extension arm portion is at least 3 feet.

6. The intimate accessory system in accordance with claim 1, wherein:
the hook portion is selectively bendable from a first bent position to a second bent position different from the first bent position; and
the hook portion has a rigidity sufficient to retain, with the phallic device coupled thereto, the first bent position and the second bent position, without external support forces.

7. The intimate accessory system in accordance with claim 1, wherein:
the hook portion is formed as a flexible, articulatable gooseneck tubing.

8. The intimate accessory system in accordance with claim 1, wherein:
the gripping handle portion and the extension arm portion are fixedly coupled to one another; and
the hook portion is formed as a flexible hinge portion operably configured to selectively rotate the phallic device, relative to the extension arm portion, within at least a 45 degree range of movement.

9. The intimate accessory system in accordance with claim 1, wherein:
the phallic device coupling portion includes a clamp that fits within a base coupled to the second end, and a clamp ring that threads onto the clamp, and wherein the clamp has anti-rotation features that engage corresponding features in the base.

10. The intimate accessory system in accordance with claim 1, wherein:
the gripping portion is angled towards a user side of the extension arm.

11. The intimate accessory system in accordance with claim 10, wherein the gripping portion is angled at an angle of 30 to 45 degrees with respect to an axis of the extension arm portion.

12. The intimate accessory system in accordance with claim 1, wherein:
the extension arm portion is formed of three telescoping sections.

13. An intimate accessory system comprising:
a phallic device support arm including:
a first end and a second end opposite the first end;
an extension arm portion between the first end and the second end comprised of at least two telescoping sections and adjustable between a minimum length and a maximum length, wherein the telescoping sections are releasably fixed in place by a clutch clamp;
a gripping handle portion disposed at the first end, the gripping handle portion dimensioned and configured to receive a grip of a human user; and
a hook portion; and
a phallic device fixedly coupled to the second end of the phallic device support arm, the hook portion being formed as an arcuate shape between the phallic device and the extension arm portion.

14. The intimate accessory system in accordance with claim 13, wherein:
the phallic device has an orifice-insertion end portion dimensioned and configured for insertion within a human sexual orifice; and
the hook portion is disposed to orient the orifice-insertion end portion of the phallic device in a direction towards the gripping handle portion.

15. The intimate accessory system in accordance with claim 13, wherein:
the minimum length of the extension arm portion is at least 2 feet.

16. The intimate accessory system in accordance with claim 13, wherein:
the hook portion is selectively bendable from a first bent position to a second bent position different from the first bent position; and
the hook portion has a rigidity sufficient to retain the first bent position and the second bent position, without external support forces.

17. The intimate accessory system in accordance with claim 13, wherein:
the hook portion is formed as a flexible, articulatable gooseneck tubing.

18. The intimate accessory system in accordance with claim 13, wherein:
the gripping handle portion is angled towards a user side of the extension arm, wherein the gripping handle portion is angled at an angle of 30 to 45 degrees with respect to an axis of the extension arm portion.

19. An intimate accessory kit with interchageable phallic devices comprising:
a phallic device support arm including:
a first end and a second end opposite the first end;
an extension arm portion between the first end and the second end;
a gripping handle portion disposed at the first end, the gripping handle portion dimensioned and configured to receive a grip of a human user;
a phallic device coupling portion disposed at the second end of the phallic device support arm, the phallic device coupling portion includes a clamp that fits within a base coupled to the second end, and a clamp ring that threads onto the clamp, and wherein the clamp has anti-rotation features that engage corresponding features in the base; and
a hook portion forming an arcuate shape between the phallic device coupling portion and the extension arm portion; and
a first phallic device dimensioned and configured to removeably couple to the phallic device coupling portion, including a base flange that is captured and retained between the clamp and the clamp ring.

20. The intimate accessory kit in accordance with claim 19,wherein:
the gripping handle portion is angled towards a user side of the extension arm portion, wherein the gripping handle portion is angled at an angle of 30 to 45 degrees with respect to an axis of the extension arm portion.
